(19) United States
(12) Patent Application Publication
(10) Pub. No.: US 2024/0125366 A1
(43) Pub. Date: Apr. 18, 2024

(54) PAD-HOLDING SPRING AND PAD RETURN SPRING ASSEMBLY, PAD ASSEMBLY, BRAKE CALIPER

(71) Applicant: Brembo S.p.A., Curno (IT)

(72) Inventors: Davide D'ALESSIO, Curno (IT); Alberto BOSIS, Curno (IT); Cristian CRIPPA, Curno (IT); Mattia CARMINATI, Curno (IT)

(21) Appl. No.: 18/484,788

(22) Filed: Oct. 11, 2023

(30) Foreign Application Priority Data
Oct. 14, 2022 (IT) 102022000021219

(51) Int. Cl. F16D 65/097; F16D 65/00

(52) U.S. Cl. CPC F16D 65/0979; F16D 65/0068; F16D 2055/0029

(57) ABSTRACT

A pad-holding spring and pad return spring assembly for a brake caliper may have at least one pad-holding spring arranged between at least one guiding ear of a brake pad and a caliper body to bias the brake pad, and a pad return spring. The pad-holding spring has a main extension and at least one C-shaped section. The pad return spring may have an anchoring portion connected to the C-shaped section, a coupling portion to couple the brake pad, and a linking arm connected to the anchoring portion and the coupling portion. The coupling portion is movable with respect to the anchoring portion between a retracted resting position and at least one advanced position, towards the disc, and vice versa. The pad return spring may have at least one winding portion connecting the linking arm to the anchoring portion.

### FIELD

The present invention relates to a brake caliper spring assembly capable of biasing a brake pad in axial, circumferential, and radial directions to reduce vibration and move the pad away from the brake disc when braking is completed to eliminate or reduce the residual torque between the friction material and the brake disc.

### BACKGROUND

Disc brake spring assemblies configured to elastically retain and bias at least one brake pad in a brake caliper are known.

In particular, documents US20180223928, U.S. Pat. Nos. 9,677,629, 8,869,950 and CN207989608U show spring assemblies having a pad-holding spring operatively connected to a pad return spring.

Usually, the pad-holding springs retain the pads inside their seats obtained in the brake caliper without limiting the movement thereof in the axial direction so as to reduce the vibrations thereof.

The pad return spring instead biases the brake pads away from the disc after each braking action so as to reduce or eliminate a residual braking torque (residual torque) due to undesired contacts between the pads and the brake disc with the brake deactivated.

Some known solutions include spring assemblies in which the pad-holding spring is made in one piece with the pad return spring. Such springs are made from a single piece of shaped and bent sheet metal and thus it is necessary to make different types of springs for each different field of application of the disc brake. Such solutions are particularly disadvantageous in terms of production costs, since a specific spring assembly is required for each different disc brake application.

Other well-known solutions comprise spring assemblies in which the pad-holding spring and the pad return spring are made from separate shaped and bent pieces of sheet metal and are then assembled. The pad return springs can thus be customized according to the application requirements of the braking system. However, the employment of axial leaf springs, particularly in the case of high-performance brake applications, raises issues of envelope and weight gain negatively affecting the performance of the vehicle on which the brake is mounted.

Still other solutions provide spring assemblies in which the pad-holding spring and the pad return spring are made from a shaped and bent piece of sheet metal and a wire spring, which are then assembled. Solutions of this type are known, for example, from documents GB2257483 and US2013025981.

In this type of solutions, the pad return spring is a wire spring having at least one elastic return portion. The elastic return portion extends in a longitudinal spring direction with one or more bends in a bending plane comprising an axial direction, parallel to the direction of the rotation axis of the brake disc, and the radial direction, perpendicular to the axial direction. The elastic return portion thus bends elastically in the bending plane, elastically biasing a coupling portion of the spring in the axial direction, between an axially advanced position and an axially retracted resting position. The spring coupling portion is connected to the brake pad so that the elastic return portion biases the brake pad away from the disc once the braking action is completed.

It was found that the geometries with which the elastic return portion of the spring of the known solutions is bent make the axial rigidity of the elastic return portion quite significant, generating highly large loads applied by the spring to the pad as the wear of the friction material of the brake pad increases.

It was found that during the assembly of the spring assembly to the caliper body and of the brake pads, given the geometry with large envelope in the axial direction and in the radial direction, the elastic return portion can undergo impacts and/or can be accidentally biased, causing a plastic deformation in the elastic return portion which modifies the bending geometry thereof, compromising the operation, even hindering the return of the pad, resulting in an accelerated wear of the friction material and an increase in the maintenance operations on the brake caliper or a disc brake.

Therefore, the need to provide pad-holding spring and pad return spring assemblies is strongly felt, in which the pad return wire spring is shaped so as to prevent or reduce possible plastic deformations for the pad return wire spring during the assembly or maintenance.

Additionally, the pad return wire springs connected to the pad-holding springs have an envelope along the longitudinal extension thereof, in particular in the axial and/or radial direction, and a bend geometry of the elastic return portion in the bending plane which prevent them from being used for different types of calipers.

Therefore, in the industry the need to provide pad-holding spring and pad return spring assemblies, in which the pad return wire spring is shaped so as to simply allow higher application versatility, allowing the employment of a bending geometry usable for a plurality of brake calipers, is strongly felt.

Therefore, a need arises to manufacture spring assemblies, pad assemblies and brake calipers which are capable of simultaneously offering, during the braking, particularly efficient performance in reducing, or even suppressing, any residual torque at the end of braking, and vibration and noise minimization properties, while allowing high adaptability and ease of modification so as to be used in various fields of application, and desired performance of disc brakes without affecting time and costs during the design and manufacturing.

Therefore, it is the problem underlying the present invention to devise a spring assembly, a pad assembly and a brake caliper, which have structural and functional features such as to meet the aforesaid needs while obviating the drawbacks mentioned with reference to the prior art and meeting the aforesaid felt needs.

### SUMMARY

It is an object of the present invention to provide a pad-holding spring and pad return spring assembly, as well as a brake pad assembly, as well as a brake caliper which allow reducing, if not eliminating, the residual torque once a braking action is completed, and which allow increasing the braking reliability.

These and other objects and advantages are achieved by a pad-holding spring and pad return spring assembly, as well as a brake pad assembly, as well as a brake caliper according to the claims.

Some advantageous embodiments are the subject of the dependent claims.

The analysis of this solution showed that the suggested solution allows obtaining a pad-holding spring and pad return spring assembly in which the pad return spring is axially compact, reducing the envelope of the pad return spring and allowing a simplified assembly without the risk of an accidental plastic deformation of the pad return spring during the assembly and maintenance operations.

The analysis of this solution showed that the suggested solution allows obtaining a pad-holding spring and pad return spring assembly in which the pad return spring has a highly small axial envelope as compared to the known solution, the elastic return force being equal.

The analysis of this solution showed that the suggested solution allows obtaining a pad-holding spring and pad return spring assembly in which the pad return spring has a lower axial rigidity as compared to the known solution, the elastic return force being equal, allowing a simplified assembly and an increase in the axial load due to the wear of the friction material which is lower than in the known solution.

The analysis of this solution showed that the suggested solution allows obtaining a pad-holding spring and pad return spring assembly in which the pad return spring works in the axial direction substantially by traction, avoiding the creation of elastic return portions having bends in a bending plane comprising the axial direction and the radial direction, which are adapted to bend for generating the elastic return force.

The analysis of this solution showed that the suggested solution allows obtaining a higher residual torque reduction between the pad and brake disc than the solutions of the prior art, thus a reduction in the events of uneven brake pad wear and in particular a reduction in the maintenance events.

Moreover, the suggested solution maintains a very high, or even improved, braking efficiency, for example the efficiency is strongly improved by virtue of the absence of frictional contact between the pad return spring and the pad-holding spring during normal operation.

Additionally, the suggested solutions allow increasing the service life of the pad-holding spring and pad return spring assembly compared to known solutions, and drastically reducing the maintenance interventions.

Even additionally, by virtue of the suggested solutions, it is possible to ensure simple spring assembly solutions according to the desired braking performance while maintaining a uniform pad-holding spring for various applications and modifying the pad return spring according to the applications in a highly simple manner while maintaining a small axial envelope of the pad return spring. In particular, in a highly simple manner, it is possible to provide different diameters of pad return springs and/or a different number of pad return spring windings and/or a different winding diameter of the pad return spring windings depending on the applications required.

Still additionally, by virtue of the suggested solutions, due to the small axial and radial envelope, it is possible to obtain a free space in the brake caliper on which the pad return spring and pad-holding spring assembly is mounted, which allows a designer to add further elements.

### DESCRIPTION OF THE DRAWINGS

Further features and advantages of the pad-holding spring and pad return spring assembly, the pad assembly, and the brake caliper will become apparent from the following description of preferred embodiments thereof, given by way of non-limiting indication, with reference to the accompanying drawings, in which:

FIG. 1 shows an axonometric view of a brake caliper according to the present invention, comprising a caliper body, at least one brake pad, and at least one pad-holding spring and pad return spring assembly according to the present invention, which is connected to the caliper body and the at least one brake pad;

FIG. 2 shows an axonometric view of a pad assembly comprising a pad-holding spring and pad return spring assembly according to the present invention, connected to a brake pad, in which a brake disc facing the brake pad is diagrammatically shown;

FIG. 3 shows a front view of the pad assembly in FIG. 2, where there is shown a pad support plate on the side opposite to the brake disc, where there is shown the at least one wire spring winding being coaxial to the axial direction which allows returning the brake pad in the axial direction;

FIG. 4 shows a front view, diametrically opposite to the front view in FIG. 4, of the pad assembly in FIG. 2, where there is shown the pad friction material and the brake disc side surface of the plate, where there is shown the coupling portion in contact with the brake disc side surface of the plate, at the ear of the pad, in which the coupling portion is bent so as to prevent an involuntary disconnection of the pad return spring from the brake pad;

FIG. 5 shows an axonometric view of the pad-holding spring and pad return spring assembly according to the present invention, in which the pad return spring comprises at least one wire portion comprising a winding being coaxial to the axial direction so as to work in traction in the axial direction, and in which the end portion of the wire portion forms at least one bend in a plane perpendicular to the axial direction;

FIG. 6 shows a front view, perpendicular to the axial direction, of the pad-holding spring and pad return spring assembly in FIG. 5 on the brake disc side, where in the foreground there is shown the end portion of the pad return spring wire portion having a bent portion in a plane perpendicular to the axial direction, and where in the background there is shown the at least one winding of the pad return spring wire portion;

FIG. 7 shows a side view, perpendicular to the tangential direction, of the pad-holding spring and pad return spring assembly in FIG. 5, where there is shown the at least one winding having a much smaller axial envelope than the envelope of the central portion of the wire portion that connects, by axially extending, the at least one winding and the coupling portion bent in the plane perpendicular to the axial direction;

FIG. 8 shows an axonometric view of a further embodiment of a pad-holding spring and pad return spring assembly according to the present invention, where there are shown two pad-holding spring and pad return spring assemblies from FIG. 5, which are mutually specular with respect to a central plane perpendicular to the axial direction and connected by a bridge-like portion;

FIG. 9 shows an axonometric view of a connecting portion of the pad return spring wire portion connected to the pad-holding spring by riveting;

FIG. 10 shows another axonometric view of a connecting portion of the pad return spring wire portion connected to the pad-holding spring by riveting;

FIG. 11 shows an axonometric view of a connecting portion of the pad return spring wire portion connected to the pad-holding spring with an opposite disc side end portion of the S-bent pad return spring so as to be inserted into a hole of the pad-holding spring, and the S-bent portion in contact with opposite surfaces of a wall of the pad-holding spring and retained by a coupling element;

FIG. 12 shows another axonometric view of a connecting portion of the pad return spring wire portion connected to the pad-holding spring with an opposite disc side end portion of the S-bent pad return spring so as to be inserted into a hole of the pad-holding spring, and the S-bent portion in contact with opposite surfaces of a wall of the pad-holding spring and retained by a coupling element;

FIG. 13 shows an axonometric view of the pad-holding spring and pad return spring assembly according to the present invention, in which the pad return spring comprises at least one wire portion comprising a winding being coaxial to the circumferential direction, and in which the end portion of the wire portion forms at least one bend in a plane perpendicular to the axial direction.

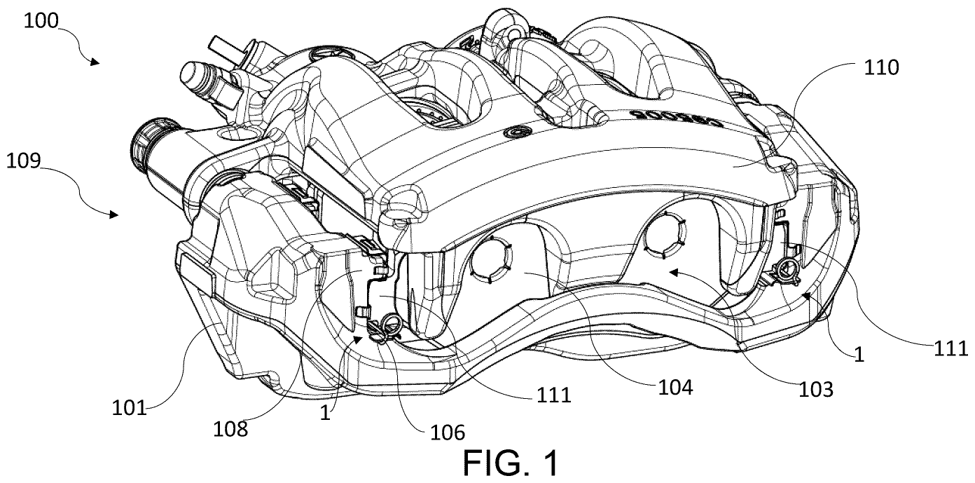

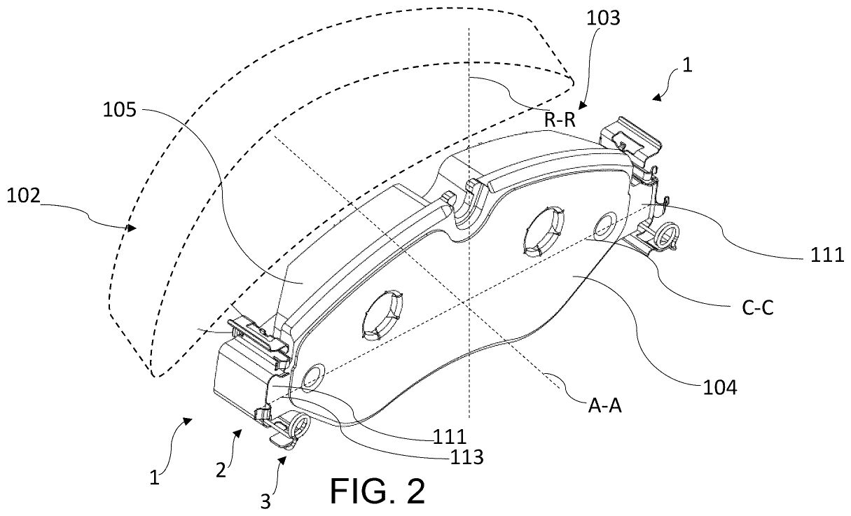

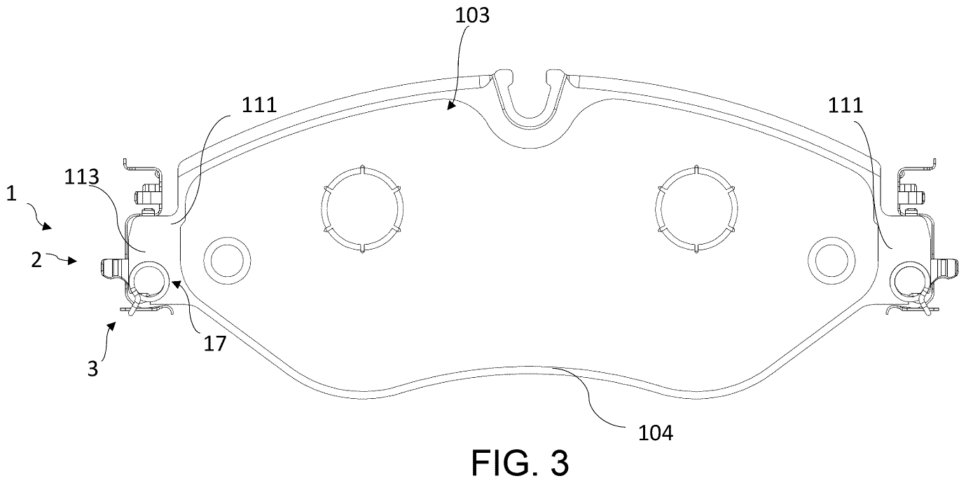

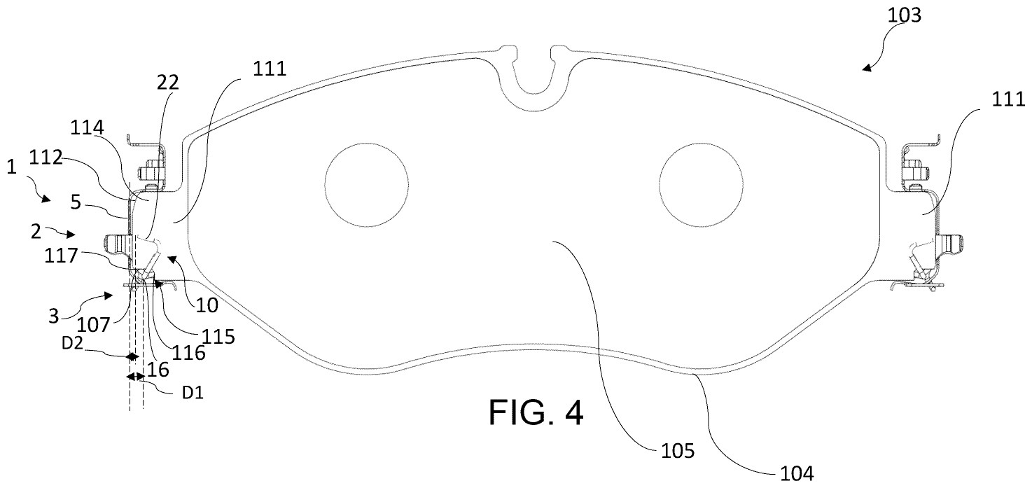

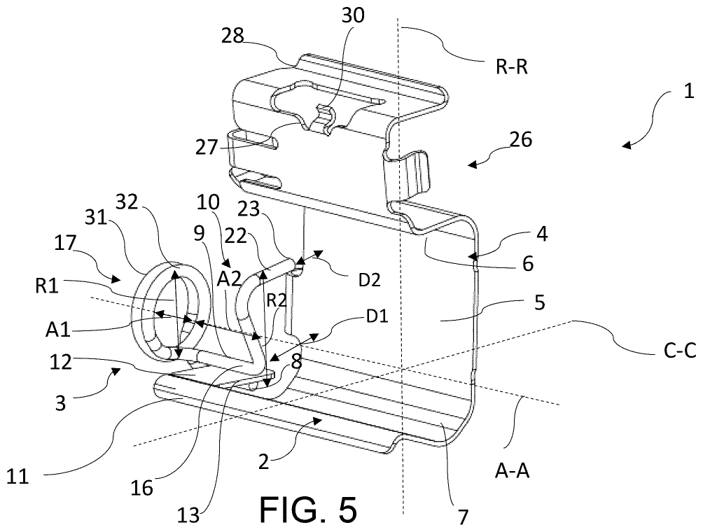

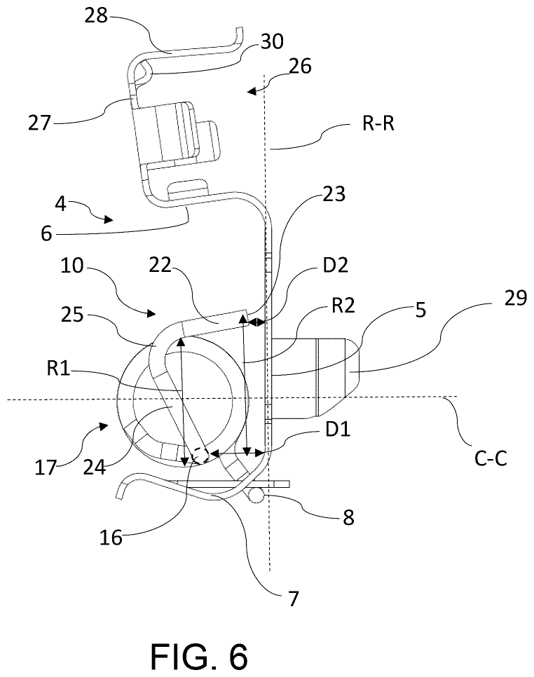

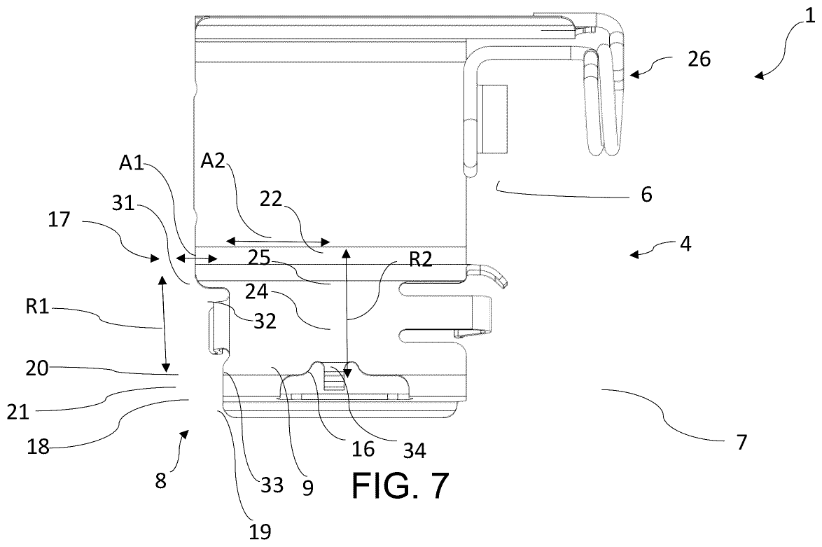

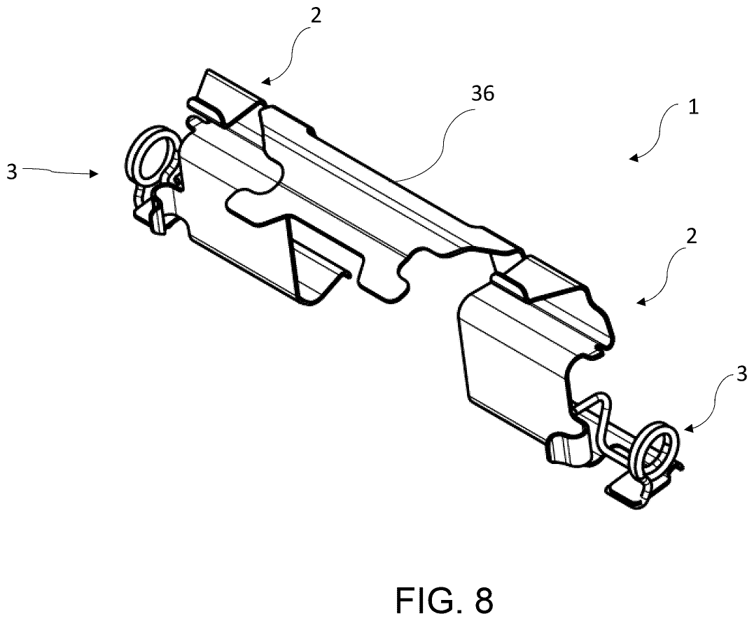

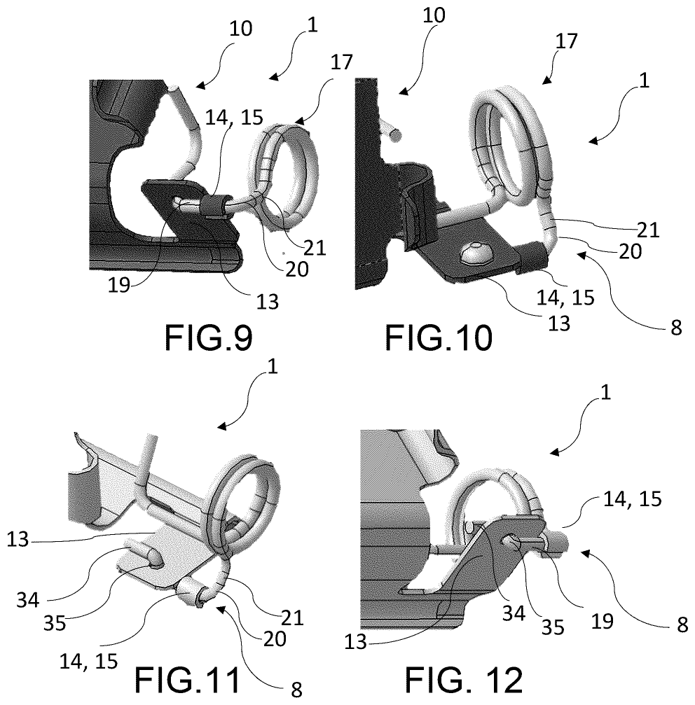

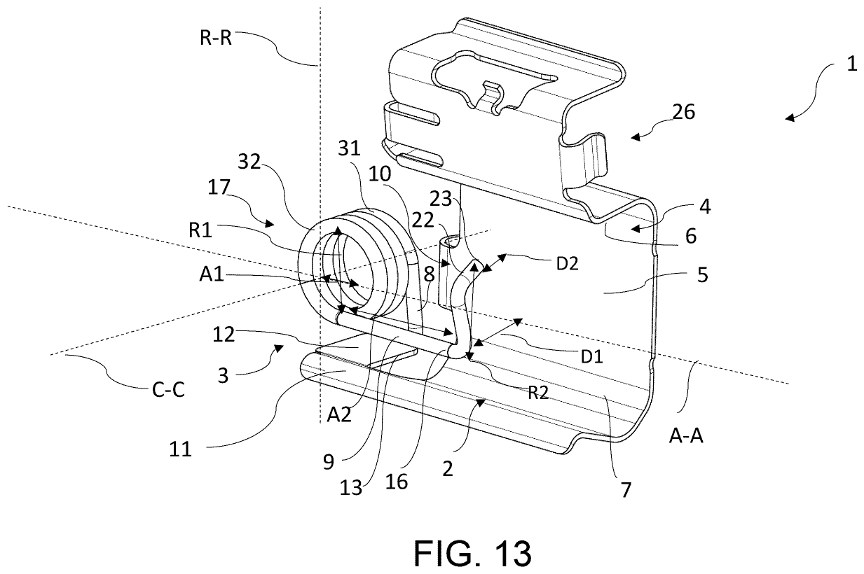

### DETAILED DESCRIPTION

According to a general embodiment, a pad-holding spring and pad return spring assembly 1 for a brake caliper 100 is provided.

In the following description, unless otherwise specified, the assembly 1 is described when it is in a resting condition not coupled to a brake pad and/or a caliper body.

Said assembly 1 defines an axial direction A-A, a radial direction R-R perpendicular to said axial direction A-A, and a circumferential or tangential direction C-C perpendicular both to said axial direction A-A and said radial direction R-R.

According to an embodiment, said axial direction A-A is parallel to a rotation axis of a brake disc 102, on which a caliper body 109 of the brake caliper 100 can be placed in a straddling manner.

Said assembly 1 comprises at least one pad-holding spring 2 and at least one pad return spring 3, made of different semi-finished products and then operatively connected.

Said pad-holding spring 2 is configured to be arranged between at least one guiding ear 111 of a brake pad 103 of the brake caliper 100 and the caliper body 109 of the brake caliper 100 so as to bias said brake pad 101 in the radial direction R-R and circumferential direction C-C.

Said pad return spring 3 is configured to bias said brake pad 101 in the axial direction A-A away from a brake disc 102.

Said pad-holding spring 2 has a main extension in the radial R-R and circumferential C-C directions.

Said pad-holding spring 2 comprises at least one C-shaped section 4. Said C-shaped section 4 comprises a central portion 5, an upper portion 6, and a lower portion 7. The central portion 5 extends at least in a radial direction R-R, mainly along said radial direction R-R. The upper portion 6 and the lower portion 7 extend in a cantilevered manner at least partially in the circumferential direction C-C from said central portion 5, extending from two radially opposite ends of the central portion 5. According to an embodiment, the central portion 5 extends at least in the radial direction R-R and the axial direction A-A. According to an embodiment, the upper portion 6 and the lower portion 7 also extend in the axial direction A-A. According to an embodiment, the upper portion 6 and the lower portion 7 extend in a cantilevered manner from two radially opposite ends of the central portion 5 along a longitudinal direction comprising the circumferential direction C-C and the radial direction R-R.

Said C-shaped section 4 is adapted to be inserted into a recess 106 of said caliper body 109 and is adapted to accommodate said guiding ear 111.

Said pad return spring 3 comprises an anchoring portion 8 operatively connected to said C-shaped section 4, a coupling portion 10 configured to couple said brake pad 103, and a linking arm 9 operatively connected to said anchoring portion 8 and said coupling portion 10. Said coupling portion 10 is elastically movable with respect to said anchoring portion 8 in the axial direction A-A between a retracted resting position and at least one advanced position, towards said disc 102, and vice versa.

According to an embodiment, said anchoring portion 8 extends from said C-shaped section 4 in the axial direction A-A in a first direction, opposite to said disc 102.

According to an embodiment, said linking arm 9 extends from said anchoring portion 8 along a longitudinal arm direction oriented in an axial direction A-A mainly in a second direction concordant with said disc 102, opposite to said first direction.

According to an embodiment, said coupling portion 10 is elastically movable in an axial direction A-A between at least one advanced position towards said disc 102, protracted along said second direction, and a retracted resting position in the opposite direction.

Said pad return spring 3 is made from at least one wire.

Advantageously, said pad return spring 3 comprises at least one winding portion 17 connecting said linking arm 9 to said anchoring portion 8. Said at least one winding portion 17 comprises said at least one wire spirally wound about a winding axis A. Said winding axis A is oriented so as to constantly elastically bias said coupling portion 10 towards said retracted resting position along said axial direction A-A. In an embodiment, said at least one winding portion 17 constantly elastically biases said coupling portion 10 in said retracted resting position by avoiding the contact of said brake pad 103 and/or said pad-holding spring 2 with said winding portion 17.

In an embodiment, the winding axis A is oriented substantially parallel to said axial direction A-A, thereby it is possible to limit the axial extension of the pad return spring 3 by virtue of the winding portion 17 which allows storing elastic energy by bending the pad return spring into planes substantially perpendicular to the axial direction A-A. Thereby it is possible to avoid bends from being created on the at least one wire in planes comprising the axial direction, avoiding acting with portions of the pad return spring under bending for elastically moving the coupling portion 10.

In an embodiment, the winding axis A is oriented so as to be incident and/or perpendicular to the axial direction A-A or to a direction parallel thereto.

According to an embodiment, said winding portion 17 comprises a plurality of coils 31, 32 wound about said winding axis A. According to an embodiment, the plurality of coils 31, 32 elastically deforms by torsion, elastically biasing said coupling portion 10 towards said retracted resting position. According to an embodiment, the pad return spring 3 is bent so as to prevent elastic deformation by bending in the axial direction A-A in the linking arm 9 and/or in the coupling portion 10 and/or in the winding portion 17, during normal operation.

According to an embodiment, said plurality of coils 31, 32 comprises at least a first coil 31 and a second coil 32. According to an embodiment, each coil 31, 32 substantially has the same outer diameter. According to an embodiment, the coils of the plurality of coils 31, 32 have a plurality of different outer diameters. According to an embodiment, said plurality of coils 31, 32 is concentric. According to an embodiment, said plurality of coils 31, 32 is misaligned. According to an embodiment, said plurality of coils 31, 32 forms a cylindrical or conical helical spring portion.

According to an embodiment, said at least one wire has a wire diameter. According to an embodiment, said winding portion 17 has a winding pitch between said wire diameter and 4/3 of the wire diameter. According to an embodiment, said winding pitch is defined as the distance along the axial direction A-A between the center of at least two adjacent coils.

According to an embodiment, said winding portion 17 defines a first axial pad return spring envelope A1. Said linking arm 9 and said coupling portion 8 define a second axial pad return spring envelope A2. Said first axial pad return spring envelope A1 is less than the second axial pad return spring envelope A2.

According to an embodiment, said winding portion 17 defines a first radial pad return spring envelope R1. Said coupling portion 8 defines a second radial pad return spring envelope R2. The radial pad return spring envelope R1 is smaller than the second radial pad return spring envelope R2.

According to an embodiment, said winding portion 17 is bent under winding with respect to said winding axis A according to a winding direction, in which said coupling portion 10 is bent at least partially in a direction opposite to the winding direction.

By virtue of the provision of the winding portion 17, it is possible to significantly reduce the axial envelope of assembly 1, by reducing, or even eliminating, the probability of plastically deforming the pad return spring wire during the assembly operations of assembly 1 to the brake pad 103 and the caliper body 109. By virtue of the bending geometry of the pad return spring as a spiral winding of the wire about the winding axis A, it is possible to provide an elastic energy storage portion which lasts over time and is highly resistant to impacts in the circumferential or radial directions during the assembly.

By virtue of the provision of the winding portion 17 which allows obtaining a small envelope in the axial direction A-A of the pad return spring 3, while maintaining high resistance, high elastic return force applicable to the pad, and high reliability over time, it is possible to mount the assembly 1 on several geometries of existing calipers. Additionally, by virtue of the small envelope in the axial direction A-A of the pad return spring 3, it is possible to provide new calipers having small dimensions or introduce other elements by virtue of the small axial envelope.

By virtue of the provision of the winding portion 17, it is possible to reduce the axial rigidity of the pad return spring 3 with respect to pad return springs including elastic return arms with bends and extension in planes comprising the axial direction. Thereby, on the one hand, it is possible to support and elastically return the pad in a highly reliable manner even under conditions of extreme wear of the friction material, and on the other hand it is possible to obtain reliable results in a broader range of geometric tolerances as compared to the known solution.

By virtue of the provision of the winding portion 17, it is possible to increase the longitudinal length of the wire of the pad return spring 3 without increasing the axial envelope or keeping the axial envelope very low as compared to the known solution. By virtue of the provision of the winding portion 17, it is possible to bend the wire spring about a winding axis which is oriented in the same direction as the elastic return force to be applied to the pad. By virtue of the provision of the winding portion 17, the return forces applied to the pad are due to the torsional deformations of the coils of the winding portion, avoiding the generation of elastic forces by bending in the axial direction.

According to an embodiment, said linking arm 9 comprises an arm end portion 16 directly connected to said coupling portion 8. Said arm end portion 16 is arranged at a first distance D1 along said circumferential direction C-C with respect to said central portion 5 or a radial extension and/or axial extension thereof. Said coupling portion 10 comprises a first stretch 22, which is arranged at a second distance D2 along said circumferential direction C-C from said central portion 5.

Advantageously, said second distance D2 is less than said first distance D1. In the case of circumferential sliding of the coupling portion 10 with respect to the brake pad 103 towards said central portion 5, during the assembly and/or during very aggressive wear conditions of the friction material, said first stretch 22 thus interferes with said central portion 5 first preventing said arm end portion 16 from contacting said central portion 5, thus preventing the coupling portion 10 from uncoupling from the brake pad 103 on the one hand, and limiting any friction forces generated between the pad return spring 3 and the central portion 5 of the pad-holding spring 2.

According to an embodiment, said first stretch 22 has a has a free spring end 23. According to an embodiment, said free spring end 23 faces said central portion 5. According to an embodiment, said free spring end 23 is defined by a surface of a section of the wire of the pad return spring 3. According to an embodiment, the free spring end 23 has a smaller surface than the surface of a circle having the diameter of the pad return spring wire as a diameter. According to an embodiment, said free spring end 23 is configured to interfere with said central portion 5. Thereby it is possible to limit the contact surface between the pad return spring 3 and the central portion 5 in the case of accidental circumferential sliding of the coupling portion 10.

According to an embodiment, said coupling portion 10 comprises a second stretch 24. According to an embodiment, said second stretch 24 and said first stretch 22 are connected, forming a coupling portion angle. According to an embodiment, said coupling portion angle is an acute angle facing the central portion 5. According to an embodiment, said second stretch 24 and said first stretch 22 are connected, forming a concave portion where said concave portion faces the central portion 5.

According to an embodiment, the second stretch 24 and the first stretch 22 are arranged or lie on the same coupling portion plane, in which said coupling portion plane is perpendicular to said axial direction A-A. According to an embodiment, the second stretch 24 and the first stretch 22 form a V-bent portion. The provision of the first stretch 22 and the second stretch 24 allows obtaining a coupling portion 10 capable of resisting the stresses of the brake pad in a highly reliable manner even under conditions of very advanced wear of the friction material.

According to an embodiment, said first stretch 22 is a straight wire stretch, said second stretch 24 is a straight wire stretch, where said second stretch 24 and said first stretch 22 are connected by a third stretch 25, where said third stretch 25 is curved. According to an embodiment, said second stretch 24 is inclined in the coupling portion plane by a second stretch angle between 0 and 45 degrees with respect to said radial direction R-R, preferably between 15 and 30 degrees. By virtue of the arrangement and geometry of the coupling portion 10, should a frictional contact occur between the pad return spring and the pad-holding spring, the surface of the pad return spring contacting the pad-holding spring is significantly reduced as compared to the known solution. By virtue of the provision of the first stretch 22 of the coupling portion 10, with an end portion 23 thereof arranged facing said central wall 5 at a circumferential distance from the central wall 5 of the pad-holding spring 2 less than the circumferential distance from the central wall 5, or from an axial and/or radial extension thereof, of every other stretch of the coupling portion 10 and/or linking arm 9, it is possible to limit the contact area between the return spring and the pad-holding spring due to a possible tangential sliding of the pad return spring on a disc side surface of the brake pad, to a fraction of a cross section of the pad return spring wire, on the one hand thus reducing any generatable friction force, and on the other hand avoiding a wire spring portion from becoming stuck between the brake pad and the pad-holding spring, or even being removed from the brake pad, thus losing the connection.

According to an embodiment, said anchoring portion 8 has at least a first straight stretch 19, which extends away from the brake disc 102, where said first straight stretch 19 is parallel to the axial direction A-A. According to an embodiment, said anchoring portion 8 has at least a first curved stretch 18 connecting said winding portion 17 to said first straight stretch 19 to as to arrange the winding axis A of the winding portion 17 parallel or perpendicular and/or incident to the axial direction A-A. According to an embodiment, said winding portion 17 extends in a helical manner in the direction of said brake disc 102. According to an embodiment, the first curved stretch 18 is bent at a right angle.

According to an embodiment, said linking arm 9 is substantially straight and parallel to said axial direction A-A. According to an embodiment, during normal operation of the assembly, said linking arm 9 avoids elastically biasing the coupling portion 10 in the axial direction, for example by bending.

According to an embodiment, said linking arm 9 is connected to said winding portion 17 by means of a first curved connection 33 that forms a right angle with said winding portion 17 in a plane comprising at least said axial direction A-A so as to arrange said linking arm 9 parallel to said axial direction A-A.

According to an embodiment, said second stretch 24 is connected to said arm end portion 16 and/or said linking arm 9 by means of a second curved connection 34, substantially forming a right angle between said linking arm 9 and said coupling portion 10.

According to an embodiment, said anchoring portion 8 has a second straight stretch 21 connected to said first curved stretch 18. According to an embodiment, said anchoring portion 8 has a second curved stretch 20 from which the winding portion 17 extends, where the second curved stretch 20 and the second straight stretch 21 lie at least partially on a plane perpendicular to the axial direction A-A.

According to an embodiment, said pad-holding spring 2 comprises a coupling wall 13, where said anchoring portion 8 of said pad return spring 3 is anchored to said coupling wall 13 of said pad-holding spring 2.

According to an embodiment, said anchoring portion 8 is coupled at least to one surface of said coupling wall 13 facing the concavity delimited by the C-shaped section 4 in the radial direction R-R.

According to an embodiment, said pad-holding spring 2 comprises a coupling element 14 connected to said coupling wall 13. According to an embodiment, said coupling element 14 comprises at least a pair of coupling tabs 15 configured to tighten at least one portion of said anchoring portion 8. According to an embodiment, the pair of coupling tabs 15 is tightened to the first straight stretch 19 of the anchoring portion 8. According to an embodiment, said anchoring portion 8 of said pad return spring 3 is riveted to said coupling wall 13. In an embodiment, said anchoring portion 8 of said pad return spring 3 is welded to said coupling wall 13. In an embodiment, said anchoring portion 8 of said pad return spring 3 is coupled by interference to said coupling wall 13. In an embodiment, said anchoring portion 8 of said pad return spring 3 is connected to said coupling wall 13 exclusively by welding.

According to an embodiment, said anchoring portion 8 comprises a third straight stretch 34 connected to said first straight stretch 19 by means of a third curved stretch 35 so as to form an S-bent anchoring portion end portion. According to an embodiment, the first straight stretch 19 is in contact with a lower surface of the coupling wall 13 facing the opposite side with respect to the enclosed portion of the C-shaped section 4. According to an embodiment, the coupling wall 13 has a through hole in which at least one portion of the anchoring portion 8 is inserted. According to an embodiment, the third curved stretch 35 is inserted into the hole of the coupling wall, and the third straight stretch 34 is in contact with an upper surface of the coupling wall 13, facing the enclosed portion of the C-shaped section 4, radially opposite to said upper surface of the coupling wall 13 so as to connect the pad return spring 2 to the pad-holding spring 3. According to an embodiment, said anchoring portion 8 comprises a third straight stretch 34 connected to said first straight stretch 19 by means of a third curved stretch 35 so as to form an L-bent anchoring portion end portion.

According to an embodiment, said pad-holding spring 2 comprises a first cantilevered portion 11 operatively connected to said lower portion 7 extending in a cantilevered manner in an axial direction A-A in the direction opposite to said brake disc 102, where said pad-holding spring 2 comprises a second cantilevered portion 12 operatively connected to said first cantilevered portion 11 extending in a cantilevered manner in a circumferential direction C-C, where said anchoring portion 8 of said pad-holding spring 2 is fixed to said second cantilevered portion 12, where said second cantilevered portion 12 comprises said coupling wall 13.

According to an embodiment, said assembly 1 comprises two pad-holding springs 2, two pad return springs 3, and a bridge-like portion 36 connecting said two pad-holding springs 2.

According to an embodiment, said pad return spring 3 is made with two parallel wires placed side-by-side.

According to an embodiment, said pad-holding spring 2 comprises an L-shaped section 26 seamlessly operatively connected to said C-shaped section 4. According to an embodiment, said L-shaped section 26 comprises a first support portion 27 operatively connected perpendicularly to a second support portion 28. According to an embodiment, the first support portion 27 extends perpendicularly from said upper portion 6 of said C-shaped section 4 so as to obtain, with said upper portion 6 and said second support portion 28, a U-shaped section having concavity opposite to said C-shaped section 4. According to an embodiment, the central portion 5 of said C-shaped section 4 comprises a first retaining element 29 which extends in a cantilevered manner in a circumferential direction C-C outside the concavity of said C-shaped section 4. According to an embodiment, said L-shaped section 26 comprises an opening between said first support portion 27 and said second support portion 28, and said first support portion 27 comprises a second retaining element 30 which extends in a cantilevered manner in a circumferential direction C-C into said opening. According to an embodiment, said first support portion 27 comprises a pair of retaining elements which project from opposite edges in a circumferential direction C-C into said L-shaped section 26.

In an embodiment, the brake pad 103 is an outer side brake pad or an inner side brake pad, where the outer side brake pad is further spaced apart from the vehicle as compared to the inner side brake pad. In an embodiment, the inner side brake pad is adapted to be biased directly by thrust means or pistons of the brake caliper, and the outer side brake pad is adapted to be biased indirectly by said thrust means or pistons of the brake caliper by means of a portion of the floating element 110 of the caliper body 109. In an embodiment, each pad return spring 3 connected and/or adapted to be connected to the outer side brake pad defines an outer side return load. In an embodiment, each pad return spring 3 connected and/or adapted to be connected to the inner side brake pad defines an inner side return load. In an embodiment, the inner side return load is equal to the outer side return load. In a brake caliper of the floating type which supports the pair of brake pads comprising the inner side brake pad and the outer side brake pad, once the braking action is completed, the pad return springs 3 acting on the inner side brake pad thus work in a symmetric manner and with the same elastic behavior as the pad return springs 3 acting on the outer side brake pad. In an embodiment, the inner side return load is lower than the outer side return load. In a brake caliper of the floating type which supports the pair of brake pads comprising the inner side brake pad and the outer side brake pad, once the braking action is completed, the pad return springs 3 acting on the inner side brake pad thus work in an asymmetric manner with respect to the pad return springs 3 acting on the outer side brake pad. By virtue of the provision of the outer side return load increased as compared to the side return load, in addition to allowing the brake pads to move away from the brake disc, a return force is applied by the pad return springs 3 to the floating element 110 of the caliper body in the resting position thereof by moving away from the vehicle, helping it to be partially re-centered with respect to the brake disc and ensuring a complete detachment of the brake pads with respect to the disc.

The present invention also relates to a brake pad assembly for a brake caliper 100. The brake pad assembly comprises at least one brake pad 103 and at least one pad-holding spring and pad return spring assembly 1 according to any one of the embodiments described above.

Said pad-holding spring and pad return spring assembly 1 is connectable to said brake pad 103. Said brake pad 103 comprises a friction material 105 and a support plate 104 which supports said friction material 105. Said support plate 104 comprises at least one guiding ear 111 which protrudes laterally in the circumferential direction C-C. Said C-shaped section 4 of said pad-holding spring 2 is configured to accommodate said at least one guiding ear 111 so as to bias said pad 103 in a circumferential direction C-C and a radial direction R-R. Said coupling portion 10 of said pad return spring 3 is configured to couple said guiding ear 111 to bias said pad 103 in a direction away from a brake disc 102 by means of said winding portion 17. According to an embodiment, said winding portion 17 is axially spaced apart from said coupling portion 10 of at least said linking arm 9. According to an embodiment, said winding portion 17 is partially external with respect to the footprint of the support plate 104. According to an embodiment, said winding portion 17 is partially external with respect to the footprint of said guiding ear 111. In this description, footprint means the profile of an element with respect to a plane perpendicular to the axial direction A-A. According to an embodiment, said winding portion 17 avoids directly contacting said support plate 104.

According to an embodiment, said brake pad 103 comprises an ear side edge 112 which laterally delimits said at least one guiding ear 111 in the circumferential direction C-C and radial direction R-R. According to an embodiment, said brake pad 103 comprises a rear ear guiding surface 113 facing the opposite side with respect to said friction material 105, and a front first-ear surface 114 facing the same side as said friction material 105.

According to an embodiment, said ear side edge 112 is insertable into said C-shaped section 4. According to an embodiment, said coupling portion 10 is couplable to said front first-ear surface 114 so as to bias said pad 103 in the axial direction A-A constantly in a direction opposite to said friction material 105.

According to an embodiment, said ear side edge 112 defines at least one recess 115 delimited radially by a radial edge portion 116 mainly extending along said radial direction R-R and by a circumferential edge portion 117 mainly extending along said circumferential direction C-C. According to an embodiment, said radial edge portion 116 and said circumferential edge portion 117 are connected in a stepped manner, where said arm end portion 16 faces said recess 115 in the radial direction R-R facing said circumferential edge 117 and in the circumferential direction C-C facing said radial edge 116 without contacting them. According to an embodiment, said winding portion 17 partially faces said recess 115. According to an embodiment, said coupling portion 10 is in contact with said front ear surface 114 and/or with an ear corner 107 defined by the intersection of said front ear surface 114 and said circumferential edge 117 delimiting said recess 115.

The present invention also relates to a brake caliper 100 comprising at least one pad assembly according to any one of the embodiments described above.

The brake caliper 100 comprises a caliper body 109 connectable to a vehicle and adapted to be arranged straddling a brake disc 102, where said caliper body 109 comprises at least one brake pad housing pocket, where said housing pocket comprises at least one recess 10. Said pad-holding spring 2 is interposed at least between said guiding ear 111 and said recess 106. Said coupling portion 10 of said pad return spring 3 is coupled to said guiding ear 111 to bias it in a direction away from said brake disc 102.

According to an embodiment, said caliper body 109 comprises a support 101 fixedly connectable to said vehicle, where said support 101 comprises said at least one brake pad housing pocket.

According to an embodiment, said caliper body 109 comprises a floating element 110 connected in a floating manner to said support 101, said floating element being configured to be arranged straddling said brake disc 102 and to directly or indirectly bias, by means of thrust means, said brake pad 103 along said axial direction A-A towards said brake disc 102 between at least one pad resting position and one pad braking position.

According to an embodiment, said brake disc 102 comprises a disc axis, where said axial direction A-A is parallel to said disc axis.

According to an embodiment, said caliper body 109 comprises a support protuberance 108, where said L-shaped section 26 is coupled to said support protuberance 108, and/or where said support 101 comprises said support protuberance 108.

### LIST OF REFERENCE SIGNS

1 Pad-holding spring and pad return spring assembly
2 pad-holding spring
3 pad return spring
4 C-shaped section
5 central portion
6 upper portion
7 lower portion
8 anchoring portion
9 linking arm
10 coupling portion
11 first cantilevered portion
12 second cantilevered portion
13 coupling wall
14 coupling element
15 coupling tabs
16 arm end portion
17 winding portion
18 first curved stretch
19 first straight stretch
20 second curved stretch
21 second straight stretch
22 first stretch
23 free spring end
24 second stretch
25 third stretch
26 L-shaped section
27 first support portion
28 second support portion
29 first retaining element
30 second retaining element
31 first coil
32 second coil
33 first curved connection
34 second curved connection
35 third straight stretch
36 bridge-like portion
100 brake caliper
101 support
102 brake disc
103 brake pad
104 support plate
105 friction material
106 recess
107 ear corner
108 support protuberance
109 caliper body
110 floating element
111 guiding ear
112 ear side edge
113 rear ear surface
114 front ear surface
115 ear recess
116 radial edge portion
117 circumferential edge portion
A-A axial direction
R-R radial direction
C-C circumferential or tangential direction

1-10. (canceled)

11. A pad-holding spring and pad return spring assembly for a brake caliper, said brake caliper comprising a caliper body adapted to be arranged straddling a disc brake, wherein said assembly defines an axial direction, a radial direction perpendicular to said axial direction and a circumferential or tangential direction perpendicular to both said axial direction and said radial direction, said assembly comprising:
at least one pad-holding spring configured to be arranged between at least one guiding ear of a brake pad housed in said caliper body and said caliper body so as to bias said brake pad in radial direction and circumferential direction, and
a pad return spring configured to bias said brake pad in the axial direction away from a brake disc,
wherein said pad-holding spring and said pad return spring are made as separate pieces and are operatively connected,
wherein said pad-holding spring has a prevailing extension in radial and circumferential directions and comprises at least:
a C-shaped section comprising a central portion which extends at least in a radial direction from which an upper portion and a lower portion extend from its radially opposite ends, wherein said upper portion and said lower portion develop at least partially in a circumferential direction away from said central portion, wherein said C-shaped section is adapted to be inserted in a recess of said caliper body and is adapted to accommodate said guiding ear,
wherein said pad return spring comprises:
an anchoring portion operatively connected to said C-shaped section,
a coupling portion configured to couple said brake pad, and
a linking arm operatively connected to said anchoring portion and to said coupling portion, wherein said coupling portion is elastically movable relative to said anchoring portion in the axial direction between a retracted resting position and at least one advanced position, towards said disc, and vice versa,
wherein said pad return spring is made from at least one wire,
wherein said pad return spring comprises at least one winding portion connecting said linking arm to said anchoring portion, wherein said at least one winding portion comprises said at least one wire, wound as a spiral about a winding axis so as to constantly bias said coupling portion elastically at least along said axial direction towards said retracted resting position.

12. The pad-holding spring and pad return spring assembly according to claim 11,
wherein said winding portion comprises a plurality of coils wound around said winding axis, wherein the plurality of coils elastically deforms by torsion thus biasing said coupling portion elastically towards said retracted resting position, preventing elastic deformation by bending in the axial direction in the linking arm and/or in the coupling portion,
and/or wherein said at least one winding portion constantly elastically biases, along said axial direction, said coupling portion towards said retracted resting position by avoiding the contact of said brake pad and/or said pad-holding spring with said winding portion;
and/or wherein said winding axis is oriented substantially parallel to the axial direction or is incident and/or perpendicular to the axial direction or a direction parallel to it.

13. The pad-holding spring and pad return spring assembly according to claim 12,
wherein said plurality of coils comprising at least one first coil and one second coil, and/or wherein said plurality of coils are concentric forming a cylindrical or conical helical portion of the spring,
and/or wherein said at least one wire has a wire diameter, wherein said winding portion has a winding pitch comprised between said wire diameter and 4/3 of the wire diameter.

14. The pad-holding spring and pad return spring assembly according to claim 11,
wherein said winding portion defines a first pad return spring axial envelope,
wherein said linking arm and said coupling portion define a second pad return spring axial envelope,
wherein said first pad return spring axial envelope is less than the second axial pad return spring envelope,
and/or wherein said winding portion defines a first pad return spring radial envelope,
wherein said coupling portion defines a second pad return spring radial envelope,
wherein said pad return spring axial envelope is smaller than the second pad return spring axial envelope,
and/or wherein said winding portion is bent in winding relative to said winding axis according to a winding direction, wherein said coupling portion is bent at least partially in a direction opposite to the winding direction.

15. The pad-holding spring and pad return spring assembly according to claim 11,
wherein said linking arm comprises an arm end portion directly connected to said coupling portion
wherein said arm end portion is arranged at a first distance along said circumferential direction relative to said central portion or a radial extension thereof,
wherein said coupling portion comprises a first stretch, which is arranged at a second distance along said circumferential direction from said central portion, wherein said second distance is less than said first distance so that in the event of circumferential sliding of the coupling portion relative to the brake pad towards said central portion, said first stretch interferes with said central portion preventing said end arm portion from contacting said central portion.

16. The pad-holding spring and pad return spring assembly according to the preceding claim 15, comprising one or more of the following features:
wherein said first stretch has a spring free end, wherein said spring free end is adapted to face said central portion, wherein said spring free end is defined by a surface equal to a section of the spring wire, wherein said spring free end is configured to interfere with said central portion, preventing the linking arm and/or other portions of the coupling portion from contacting the central portion;
and/or wherein said coupling portion comprises a second stretch,
wherein said second stretch and said first stretch are connected forming a coupling portion angle, wherein said coupling portion angle is an acute angle facing the central portion

17. The pad-holding spring and pad return spring assembly according to the preceding claim 16, comprising one or more of the following features:
wherein said second stretch and said first stretch are connected forming a concave portion in which said concave portion faces the central portion,
wherein the second stretch and the first stretch are arranged or lie on the same coupling portion plane, wherein said coupling portion plane is perpendicular to said axial direction;
and/or wherein
said first stretch is a straight wire stretch, wherein said second stretch is a straight wire stretch, wherein said second stretch and said first stretch are connected by a third stretch, wherein said third stretch is curved;
and/or wherein
said second stretch is connected to said arm end portion, substantially forming a right angle,
wherein said second stretch is inclined in the coupling plane portion by a second stretch angle comprised between 0 and 45 degrees relative to said radial direction, preferably between 15 and 30 degrees.

18. The pad-holding spring and pad return spring assembly according to claim 11, wherein said anchoring portion has at least a first straight stretch, which extends away from the brake disc, wherein said first straight stretch is parallel to the axial direction,
wherein said anchoring portion has at least a curved first stretch which connects said winding portion to said straight first stretch to as to arrange the winding axis of the winding portion either parallel or incident and/or perpendicular to the axial direction, wherein said winding portion extends in a helical manner in the direction of said brake disc,
and/or wherein
said linking arm is substantially straight and parallel to said axial direction, wherein said linking arm is connected to said winding portion by means of a first curved connection that forms a right angle with said winding portion in a plane comprising at least said axial direction so as to arrange said linking arm parallel to said axial direction.

19. The brake pad assembly for a brake caliper, comprising at least one brake pad and at least one pad-holding spring and pad return spring assembly according to claim 11, wherein said pad-holding spring and pad return spring assembly is connectable to said brake pad,
wherein said brake pad comprises friction material and a support plate supporting said friction material, wherein said support plate comprises at least one guiding ear protruding laterally in a circumferential direction,
wherein said C-shaped section of said pad-holding spring is configured to accommodate said guiding ear so as to bias said pad in a circumferential direction and a radial direction,
wherein said coupling portion of said pad return spring is configured to engage said guiding ear so as to bias said pad in a direction away from a brake disc by means of said winding portion distanced by at least said linking arm from said coupling portion, and/or by preventing the uncoupling of said coupling portion from said brake pad.

20. The brake caliper comprising
a caliper body connectable to a vehicle and adapted to be arranged straddling a brake disc, wherein said caliper body comprises at least one brake pad housing pocket, wherein said housing pocket comprises at least one recess,
a pad assembly according to claim 9, wherein said pad-holding spring is interposed at least between said guiding ear and said recess,
wherein said coupling portion of said pad return spring is coupled with said guiding ear to bias it in a direction away from said brake disc.
